(19) United States
(12) Patent Application Publication
(10) Pub. No.: US 2015/0159621 A1
(43) Pub. Date: Jun. 11, 2015

(54) Electrical Generator

(71) Applicant: Joel D. Sims, Goodlettsville, TN (US)

(72) Inventor: Joel D. Sims, Goodlettsville, TN (US)

(21) Appl. No.: 14/540,170

(22) Filed: Nov. 13, 2014

Related U.S. Application Data
(60) Provisional application No. 61/913,480, filed on Dec. 9, 2013.

(51) Int. Cl. F03B 13/06; F03B 13/10; F02C 6/16

(52) U.S. Cl. CPC F03B 13/06; F02C 6/16; F03B 13/10; F05D 2240/128

(57) ABSTRACT

A generator system and method is provided for generating electricity using a closed-loop/self-contained system which employs a tank of pressurized fluid to turn a turbine which in turn operates a generator or alternator then the spent fluid is pumped back to the pressurized tank to continue the process.

### CROSS REFERENCE TO RELATED APPLICATIONS

This application is a continuation and claims the benefit of the filing date of U.S. provisional patent application No. 61/913,480 entitled “Electrical Generator”, which was filed on Dec. 9, 2013, by the same inventor of this application. The provisional patent application is hereby incorporated by reference as if fully set forth herein.

### FIELD OF THE INVENTION

One or more embodiments of the invention relate(s) generally to generators and more particularly to a self-contained, liquid or gas closed-loop system for generating electricity.

### BACKGROUND OF THE INVENTION

Most of the world depends upon electricity. Large electrical power plants and overlying networks have been required to satisfy this dependence. Off-grid isolated areas have either installed expensive nature-dependent systems or systems which require unsustainable resources. Additionally, after a natural disaster such as a flood, earthquake, tornado, etc. it may take months to restore power to the affected area. While portable gasoline and natural gas generators may be brought in to these areas, it may be difficult to maintain the supply of gasoline or natural gas to run these generators.

It would thus be advantageous to create a low cost electrical generator that can provide sustained electricity without the need for fossil fuels. It would also be advantageous to provide such an electrical generator that is portable.

### BRIEF SUMMARY OF THE INVENTION

Many advantages of the invention will be determined and are attained by one or more embodiments of the invention, which in a broadest sense provide(s) essentially closed systems and methods for generating electricity without the need for fossil fuels. In at least one embodiment a generator is provided which includes a fluid (e.g. liquid, gas or plasma) pumped from a reservoir into a pressurized holding tank. From the holding tank, the fluid is forced through high pressure jets and used to spin a turbine. The fluid is then returned to the reservoir for recycling through the system. The turbine may be linked to a conventional generator or alternator for producing electricity. One or more batteries is/are provided which may be charged via solar, hydro, wind power or any combination thereof and which may also receive a partial charge from the electricity generated from the system. The one or more batteries is/are employed to run a pump which pumps the fluid from the reservoir into the pressurized holding tank.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a front view of device which generates mechanical energy in accordance with one or more embodiments of the invention;

FIG. 2 is a side view of the device of FIG. 1 in accordance with one or more embodiments of the invention;

FIG. 3 is a left side view of an electrical generator in accordance with one or more embodiments of the invention which incorporates the device of FIGS. 1-2;

FIG. 4 is a right side view of an electrical generator in accordance with one or more embodiments of the invention which incorporates the device of FIGS. 1-2;

FIG. 5 is a rear view of an electrical generator in accordance with one or more embodiments of the invention which incorporates the device of FIGS. 1-2;

FIG. 6 is a front view of an alternate embodiment of an electrical generator in accordance with one or more embodiments of the invention which incorporates the device of FIGS. 1-2;

FIG. 7 is a right side view of the embodiment of FIG. 6

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

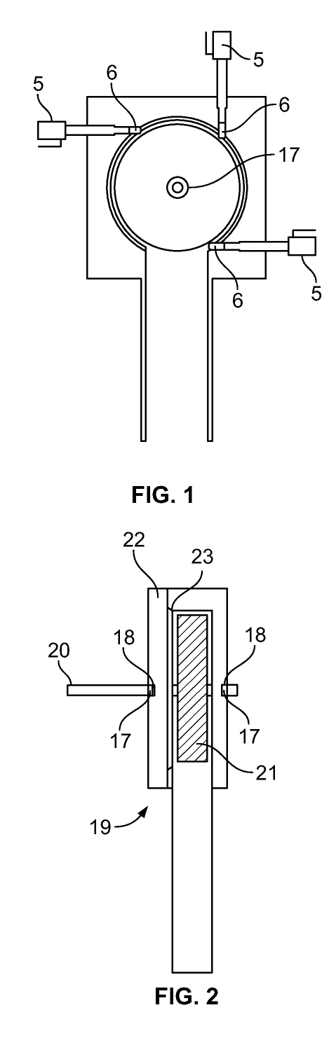

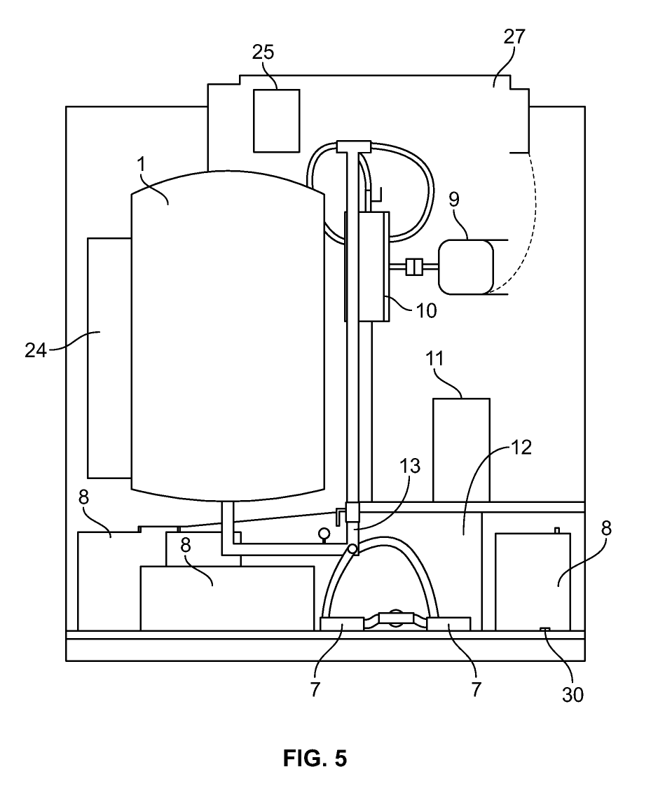

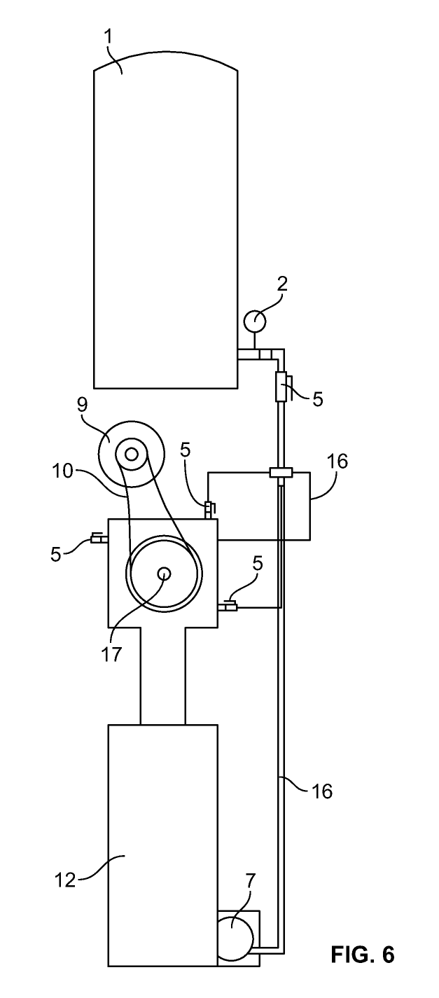

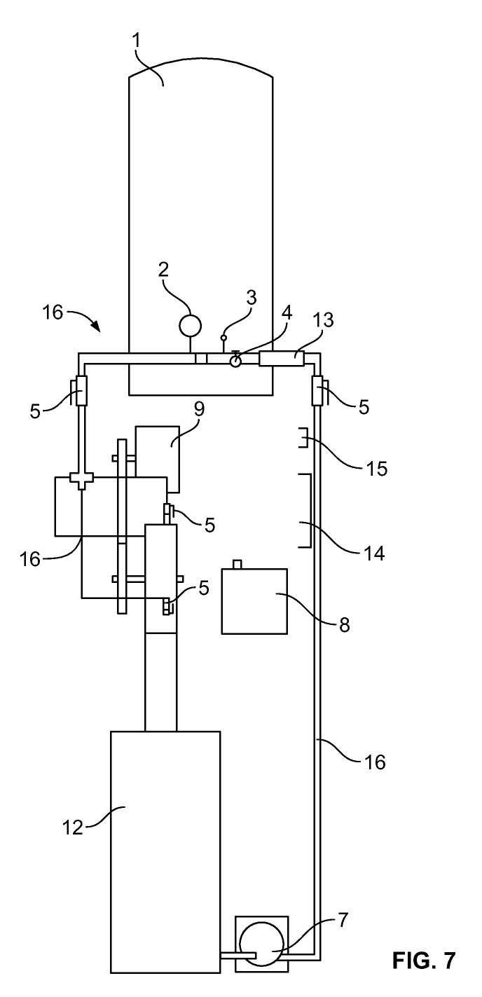

Referring to the drawings in detail wherein like reference numerals identify like elements throughout the various figures, there is illustrated in FIGS. 1-7 electrical generator systems and methods according to the invention. The principles and operations of the invention may be better understood with reference to the drawings and the accompanying description.

The following elements are identified on the various Figures:
1 Diaphragm Pressure Tank
2 Pressure Valve
3 Pressure Relief
4 Water Drain Valve
5 Ball Valve
6 High Pressure Water Jet
7 Water Pump with Pressure Shut Off
8 Battery
9 Generator/Alternator
10 Hydro Box with Pelton Wheel and High Pressure Water Jets
11 Battery Controller
12 Water Storage
13 Back Flow Valve
14 Battery Charger
15 Diverter Heater
16 High Pressure Water Line
17 Sealed Pressed Bearing
18 Water Seal
19 O Ring
20 Shaft
21 Pelton Wheel
22 Lextan Cover
23 O Ring
24 110V/220V Inverter
25 Disconnect Box/Fuse
26 Breaker Box
27 Volt/Ampere Meter
28 110 Voltage Plugs
29 220V Voltage Plug
30 Fuse
31 Split Valve

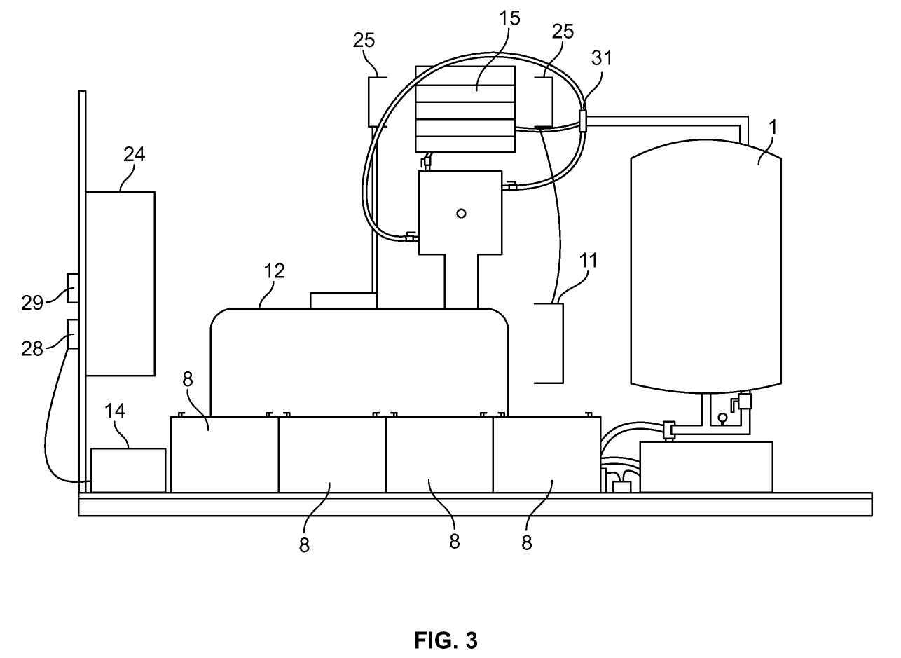

In one or more embodiments as illustrated in FIGS. 3-5 and 6-7, the system includes, among other things, a pressurized tank 1 a holding tank 12, a pump 7, battery 8, and a hydro box with a Pelton Wheel 21 (or some other type of impulse water/fluid turbine) and water jets 10. The Figures illustrate multiple batteries 8 and multiple pumps 7. Those skilled in the art will recognize that this is a design choice. There could be only one battery 8 or multiple batteries 8 and one pump 7 or multiple pumps 7. Further, there could be multiple holding tanks 12 and/or multiple pressurized tanks 1. In one or more preferred embodiments, the volume of the holding tank 12 or of the holding tanks 12 if multiple holding tanks are employed, is the same as or larger than the volume of the pressure tank 1 and holds at least as much fluid as the pump 7 can pump through the jets 10. This prevents air from entering the pump cycle and interrupting the flow. Preferably, but not required, the pressurized tank 1 holds at least as much water as the jets 1 are pumping out. This causes less wear on the pump 7 because the more the pressurized tank 1 holds the less the pump 1 has to pump. Those skilled in the art will also recognize that there are other elements to the system such as wires (which are used to connect the various electrical elements to the elements which require electricity), pipes/tubes (which are used to transport the fluid from one location to another, joints (for connecting pipes/tubes), valves (for controlling the flow of fluid through the system, belts (for transferring rotational energy from one device to another), etc., however, since this is a patent application and not a manufacturing specification the invention may best be described without delving into such minutia that would certainly be understood by those skilled in the art. The above notwithstanding, those skilled in the art will recognize that the tubes from the holding tank 12 to the pump 7 and from the pump 7 to the pressure tank 1 should, although are not required to, have the same or substantially the same diameter. The tubes from the pressure tank 1 to the split valve 31 should, but are not required to, have smaller diameters than the tubes from the holding tank 12 to the pressure tank 1 and the tubes from the split valve 31 to the jets 6 should, but are not required to, have smaller diameters than the tubes from the pressure tank 1 to the split valve 31. This compounds the pressure thus creating a higher propulsion force to the Pelton Wheel 21.

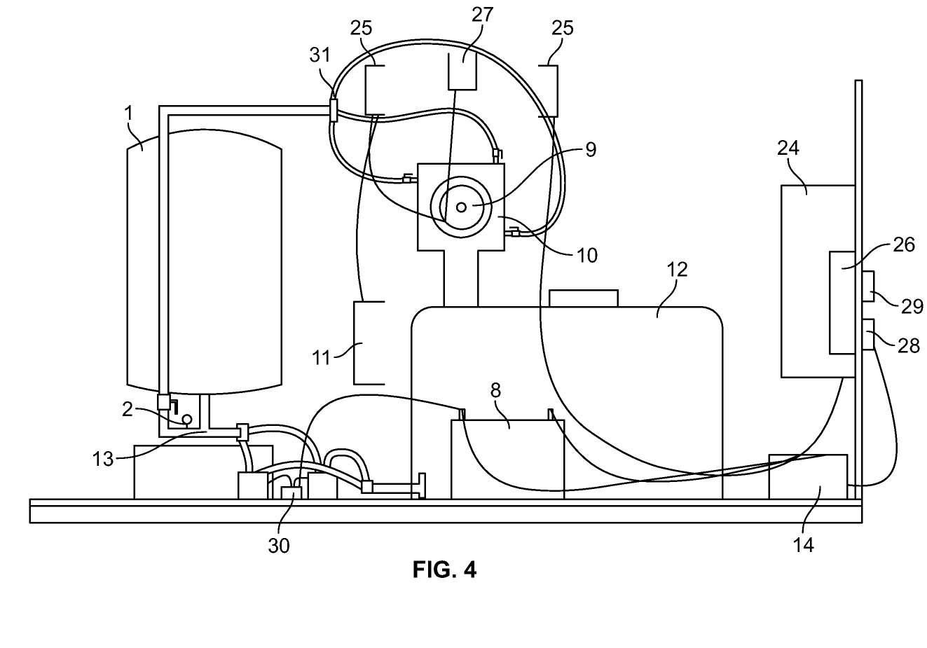

As illustrated in FIG. 3, the system may include a Diverter Heater 15 which may be used to siphon off electricity from the system in the event that too much electricity is generated. Those skilled in the art will recognize that this is a safety feature and thus not required for the operation of one or more embodiments of the invention. Those skilled in the art will also recognize that other devices or systems may be employed for the same or similar function. As illustrated in FIG. 4, the system may include a battery controller 11 and a battery charger 14. Battery Controller 11 is in electrical communication with the generator and with one or more batteries 8 and controls the amount of electricity that is sent to the one or more batteries 8. Battery Controller 11 is also in electrical communication with the Diverter Heater 15 such that if excess electricity needs to be bled from the system, batter controller 11 diverts the excess electricity to Diverter Heater 15. Battery charger 14 charges a battery 8 that is used to power the pump 7. It receives electricity from the electricity generated by the system through the one or more batteries 8. The one or more batteries 8 feed the Power Inverter 24 which connects to the main fuse box outlet 26. From the fuse box, electricity is connected to the electrical 110 volt outlet 28. The Battery Charger 14 draws its power from the 110 volt outlet 28. The Power inverter 24 is used to convert the electricity from the one or more batteries 8 from direct current (DC) to 110/220 volts alternating current (AC). Those skilled in the art will recognize that the power inverter 24 could be eliminated by using an AC Generator versus a DC Generator.

In operation, water is either inserted into the holding tank 12 or it may be initially stored in the pressure tank 1 to conserve initial battery power, or some water may be stored in the holding tank 12 and some in the pressure tank 1 depending upon the design choice of the provider. In situations where the water is placed into the holding tank 12, the battery 8 charges the pump 7 which in turn pumps water from the holding tank 12 to the pressure tank 1. From the pressure tank 1, the water is forced through high pressure jets/nozzles 6 (FIG. 1) such that it impacts the buckets of the Pelton Wheel 21 (FIG. 2) thus causing the Pelton wheel 21 to spin about its axis 20. The axis 20 includes a flywheel or gear or system of flywheels or gears or some other conventional device for transferring the rotational energy of the Pelton Wheel 21 to a conventional generator or alternator or some other device that can utilize the rotational energy provided by the system (This is not illustrated as this aspect is conventional and those skilled in the art will understand the connection(s) required for transferring the rotational energy of the Pelton wheel 21 to a conventional generator). The water, subsequent to impacting the Pelton Wheel 21, drops into the holding tank 12 where it is stored until the above process is repeated.

The system is presently set up with a reciprocating 9 gallons per minute cycle. The holding tank 12 is 40 gallons and the pressure tank 1 is 30 gallons. This leaves ten gallons in the holding tank 12 to prevent air pockets getting into the pressure tank 1. The system runs at 40 pounds per square inch (psi) pressure, however, optimal pressure is between 50 and 60 psi. Those skilled in the art will recognized that other parameters may be utilized depending upon the desired output parameters.

Having thus described a preferred embodiments of the invention, advantages can be appreciated. Variations from the described embodiments exist without departing from the scope of the invention. Thus it is seen that electrical generator systems and methods are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. By way of non-exclusive examples, the system has been described utilizing water as the liquid; however, other liquids could be employed so long as the viscosity of the other liquid is taken into consideration with regard to pressure drops and sizes of nozzles required. Additionally, the system could operate using a gas instead of the liquid and still fall within a scope of the invention. The system has been disclosed with one of each element, however, those skilled in the art will recognize that multiple storage or pressure tanks could be employed, multiple batteries, multiple turbines, or any combination thereof and still fall within a scope of the invention. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. An energy conversion apparatus comprising:
a pressurized tank configured to store a fluid;
a conduit connected to said pressurized tank;
a nozzle having an input and an output, said nozzle connected to said pressurized tank via said conduit, said nozzle configured to receive at the input, a fluid that is moving from said pressurized tank at a velocity and configured to deliver said fluid from said output of said nozzle at a faster velocity than that received at said input;
a turbine configured to be impacted by said fluid being delivered by said nozzle;
a pump configured to receive said fluid subsequent to said fluid impacting said turbine and to return said liquid to said pressurized tank.

2. The apparatus according to claim 1 further including a holding tank coupled between said turbine and said pump and configured to receive and store said fluid subsequent to said fluid impacting said turbine and prior to said fluid being pumped back to said pressurized tank.

3. The apparatus according to claim 1 wherein said nozzle is a high pressure nozzle.

4. The apparatus according to claim 1 wherein said fluid is water.

5. The apparatus according to claim 1 wherein said fluid is a gas.

6. The apparatus according to claim 1 further comprising an electrical generator connected to said turbine.

7. The apparatus according to claim 1 further comprising an alternator connected to said turbine.

8. A method of converting energy comprising:
storing a fluid within a pressurized tank;
forcing said fluid to pass from said pressurized tank through a nozzle which increases a speed of said fluid and which causes said fluid to impact a turbine; and,
pumping said fluid back to said pressurized tank subsequent to said fluid impacting said turbine.

9. The method according to claim 8 further including storing said fluid in a holding tank subsequent to said fluid impacting said turbine and prior to said fluid being pumped back to said pressurized tank.

10. The method according to claim 8 wherein said nozzle is a high pressure nozzle.

11. The method according to claim 8 wherein said fluid is water.

12. The method according to claim 8 wherein said fluid is a gas.

13. The method according to claim 8 further comprising utilizing said turbine to operate an electrical generator.

14. The method according to claim 8 further comprising utilizing said turbine to operate an alternator.
